(19) United States
(12) Patent Application Publication
(10) Pub. No.: US 2025/0374950 A1
(43) Pub. Date: Dec. 11, 2025

(54) Assembly for Dressing Beverages and Fruit

(71) Applicant: Christopher Trevino, San Antonio, TX (US)

(72) Inventor: Christopher Trevino, San Antonio, TX (US)

(21) Appl. No.: 18/929,607

(22) Filed: Oct. 28, 2024

Related U.S. Application Data
(60) Provisional application No. 63/658,653, filed on Jun. 11, 2024.

(51) Int. Cl. A23P 20/12

(52) U.S. Cl. CPC A23P 20/12

(57) ABSTRACT

The present invention is an assembly for dressing beverages and fruit. The assembly includes a container for collecting seasoning, a flexible sheet for applying seasoning, a first clip for securing a first end of the flexible sheet to the container, and a second clip for securing a second end of the flexible sheet to the container. The assembly allows a user to quickly and evenly dress irregularly shaped food items and beverage containers with seasoning. The assembly can be quickly deconstructed, facilitating the cleaning process. The invention collects leftover seasoning, thereby reducing waste and operating costs.

### CROSS REFERENCES TO RELATED APPLICATIONS

This application claims the benefit of U.S. Provisional Patent Application No. 63/658,653, filed Jun. 11, 2024, which is incorporated by reference herein in its entirety.

### BACKGROUND

In the food and beverage industry, it is common practice to dress beverages and fruit with various salts and sugars to enhance both flavor and presentation. Currently, users rely on manual application methods to dress beverages and fruit, such as sprinkling or pouring, which can often result in seasoning being applied unevenly and inconsistently. This inconsistency not only affects the quality and presentation of the beverage but also contributes to waste, as leftover seasoning cannot be reused. In addition, prior art methods lack an effective means for recycling leftover seasoning after use, resulting in the disposal of excess product. Wasted seasoning in turn drives up operational costs. For the foregoing reasons, there is a need for an invention that allows a user to more evenly and consistently dress beverages and fruit, while at the same time collecting and storing leftover product.

### SUMMARY

The present invention is directed to an assembly for dressing beverages and fruit-here forward referred to as ‘the assembly’—that allows a user to evenly apply seasoning to beverages and fruit while simultaneously collecting leftover product. The assembly comprises a container for receiving leftover seasoning, a flexible sheet for applying seasoning, a first clip for securing a first end of the flexible sheet to the container, and a second clip for securing a second end of the flexible sheet to the container.

The container further comprises an opening for receiving a beverage bottle or fruit. The opening allows a user to evenly apply the seasoning over the beverage bottle or fruit without making contact with the sidewalls of the container. The container is composed of food-grade plastics, such as polypropylene, such that the leftover seasoning will be safe for later consumption. The container may further comprise rubber feet to prevent the assembly from slipping or otherwise moving during use. The flexible sheet is composed of a flexible, elastic, and food-safe material, such as food-grade silicone or rubber. The elasticity of the flexible sheet allows a user to evenly apply seasoning to the fruit or beverage. In one embodiment, the flexible sheet is textured to facilitate the application of seasoning to the surface of the fruit or beverage bottle. The flexible sheet may additionally be treated with a non-stick coating, making the sheet easier to clean. In an alternative embodiment, the first and second clips securing the flexible sheet to the container further comprise teeth for gripping the flexible sheet. The first and second clips may be detached from the container, such that the flexible sheet can be removed therefrom. In another embodiment, the assembly further comprises a lid, such that the assembly can be deconstructed and stowed away.

Seasoning, such as spices, sugars, and salts, is sprinkled or otherwise deposited on the flexible sheet. A fruit or beverage bottle may then be rolled over the flexible sheet, thereby evenly applying the seasoning. The leftover seasoning then falls into the container below and can be recycled or stored for later use. Thus, the present invention eliminates waste and reduces operational costs, while at the same providing a more evenly dressed and presentable fruit or beverage.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a perspective view of the assembly for beverages and fruit according to the present invention;

FIG. 2 is a front view of the assembly of FIG. 1;

FIG. 3 is a top view of the assembly of FIG. 1;

FIG. 4 is a side view of the assembly of FIG. 1;

FIG. 5 is a perspective view of a second embodiment of the assembly wherein the assembly further comprises a lid;

FIG. 6 depicts an environment of use for the assembly of FIG. 1.

### DETAILED DESCRIPTION

In the Summary above and in the Detailed Description, and the claims below, and in the accompanying drawings, reference is made to particular features of the invention. It is to be understood that the disclosure of the invention in this specification includes all possible combinations of such features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Hereinafter, preferred embodiments of the present disclosure will be described in detail with reference to the accompanying drawings. Prior to the description, it should be understood that the terms or words used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the embodiments described herein and illustrations shown in the drawings are just a most preferred embodiment of the present disclosure, but not intended to fully describe the technical aspects of the present disclosure, so it should be understood that a variety of other equivalents and variations could be made thereto at the time of filing the application.

Additionally, in describing the present disclosure, when it is deemed that a detailed description of relevant known elements or functions renders the key subject matter of the present disclosure ambiguous, the detailed description is omitted herein.

The terms including the ordinal number such as “first”, “second” and the like may be used to distinguish one element from another among various elements, but not intended to limit the elements by the terms.

Unless the context clearly indicates otherwise, it will be understood that the terms “comprises” or “includes” when used in this specification, specifies the presence of stated elements, but does not preclude the presence or addition of one or more other elements. For example, an article “comprising” (or “which comprises”) components A, B, and C can consist of (i.e. contain only) components A, B, and C, or can contain not only components A, B, and C but also one or more other components. In addition, throughout the specification it will be further understood that when an element is referred to as being “connected to” another element, it can be directly connected to the other element or intervening elements that may be present.

For clarity, the phrase “seasoning” shall refer to any solid, particulate materials that can be applied to a fruit or beverage bottle to enhance the flavor, appearance, or texture of the same. Thus, “seasoning” includes but is not limited to any variety of salts, sugars, and spices, such as: sea salt, kosher salt, Applewood Smoked Salt, Himalayan pink salt, fleur de sel, black salt (kala namak), smoked salt, and flavored salts (e.g., garlic salt, onion salt), granulated sugar, brown sugar, powdered sugar (confectioners' sugar), raw sugar (turbinado), cane sugar, agave sugar, coconut sugar, honey granules, maple sugar, ground pepper, paprika, chili powder, garlic powder, onion powder, cumin, coriander, oregano, basil, cinnamon, dried herbs, flavoring powders, nutritional yeast, citric acid, and baking soda.

In addition, the present invention is illustratively described with reference to “beverage bottles.” However, the versatile design of the present invention accommodates beverage containers of a variety of shapes. For example, the present invention may be used in conjunction with a variety of beverage containers, including cups, mugs, and other similar vessels. In addition, the present invention accommodates fruits and other food items of various shapes and sizes. All descriptions henceforth referencing fruit and beverage containers are nonlimiting and are lodged for the purpose of illustrating the utility and novelty of the subject invention.

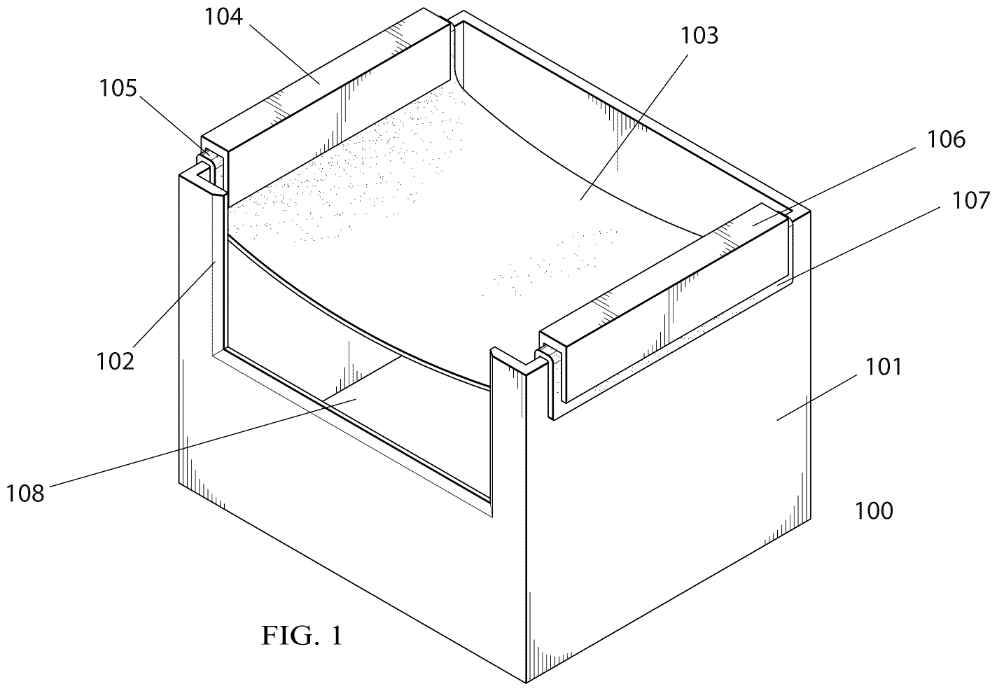

FIG. 1 depicts a perspective view of the assembly for beverages and fruit according to the present invention. The assembly 100 comprises a container for receiving leftover seasoning 101, a flexible sheet for applying seasoning 103, a first clip 104 for securing a first end of the flexible sheet 105 to the container 101, and a second clip 106 for securing a second end of the flexible sheet 107 to the container 101.

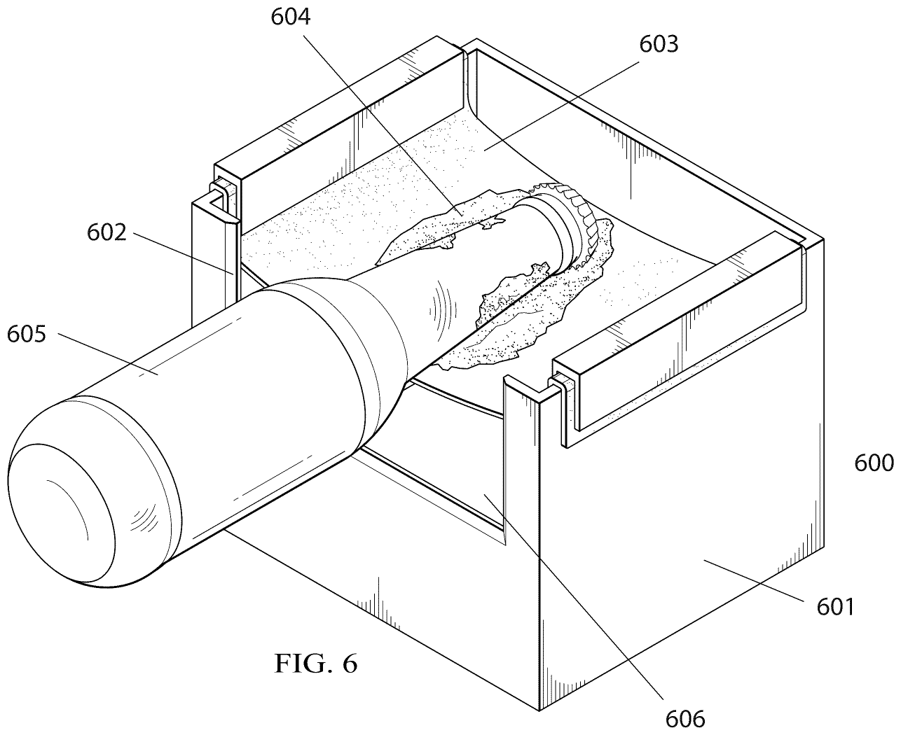

The container for receiving seasoning 101—henceforth referred to as ‘the container’—is illustratively depicted in a cube shape with a uniform height, width, and depth. However, the height, width, and depth of the container 101 need not be uniform, and need not be limited according to a particular shape or size. As illustrated in FIG. 1, the container 101 comprises a width that is less than that of the flexible sheet 103, such that leftover seasoning falls into the base of the container 108 beneath. The container 101 further comprises an opening for receiving beverages or fruit 102. The opening 102 facilitates the process of seasoning the bottle, such that the bottle does not make contact with the sidewalls of the container as the user is applying seasoning thereto. Thus, a user can more evenly apply seasoning to the bottle by pressing and rotating the bottle about the flexible sheet 103 as the bottle is in a horizontal position, as depicted in FIG. 6. The opening 102 may also be dimensioned to accommodate bottles and fruits of varying dimensions. The container may additionally comprise rubber feet (not depicted), to prevent the assembly from slipping or shifting during use.

The container 101 and first and second clips 104 106 may be made of any variety of food-safe plastics, including but limited to polyethylene (PE), polypropylene (PP), polyethylene terephthalate (PET), Crystallized Polyethylene Terepthalate (CPET), or any other food safe non-toxic material. The container 101 and first and second clips 104 106 may be formed by conventional polymer forming and working techniques. Suitable forming and working techniques include injection molding, rotational molding, and the like, as well as thermoforming. The container 101 and first and second clips 104 106 may be suitable for refrigerated storage, freezer storage, and heating without substantial deformation. It may also be possible to construct the first and second clips 104 106 from one material and the container 101 from another. For instance, the container 101 may be constructed of polypropylene (PP) and the first and second clips 104 106 may be constructed of Crystallized Polyethylene Terepthalate (CPET).

The first and second clips 104 106 securing the first and second ends 105 107 of the flexible sheet to the container function on the same mechanical principle. The first clip 104 secures the first end of the flexible sheet 105 to the container and the second clip 106 secures the second end of the flexible sheet 107 in the same manner, providing tension across the length of the flexible sheet 103. The first end of the flexible sheet 105 is secured to the container walls via the first clip 104, and the first clip 104 pressed firmly into place over the same. The first clip 104 is illustratively presented as a c-clip, but is not limited according to this design. For example, a variety of other clips are envisioned, including spring-loaded clips, latch clips, magnetic clips, and push-in clips. Nor are the first and second clips 104 106 limited according to any particular width, height, or depth of any kind. Rather, the first and second clips 104 106 are sized so as to fit within the width of the container walls. The first and second clips 104 106 may further comprise serrated edges or teeth (not depicted) with a series of pointed protrusions that grip the first and second ends 105 107 of the flexible sheet, holding the flexible sheet 103 firmly in place.

Moreover, the flexible sheet 103 provides a surface for applying seasoning. The flexible sheet 103 may be composed of a variety of elastic, food-safe materials, including polyurethane, natural rubbers, and thermoplastic elastomers. In the preferred embodiment, the flexible sheet 103 is 1.0 mm thick, but is not limited to any particular dimensions. The flexible sheet 103 conforms to a variety of bottle shapes and sizes, ensuring an even application of seasoning about the surface of the bottle. The flexible sheet 103 may also feature a textured surface designed to enhance its performance and improve the application of seasoning. This texture can take various forms, such as raised patterns, grooves, or ridges, which serve multiple purposes. This feature is particularly beneficial when applying seasoning to curved or irregular surfaces. The textured surface also creates channels that facilitate the even distribution seasoning, allowing for a more controlled and uniform application across the bottle's surface. Additionally, the textured design prevents seasoning from clumping, which results in wasted product.

The flexible sheet 103 may also be treated with a food-safe non-stick coating that creates a smooth, low-friction surface. The non-stick coating minimizes the accumulation of residue. Various food-safe non-stick coatings can be employed, including polytetrafluoroethylene (PTFE), which offers high thermal stability and durability; and ceramic-based coatings that provide a non-toxic, environmentally friendly alternative that is scratch-resistant.

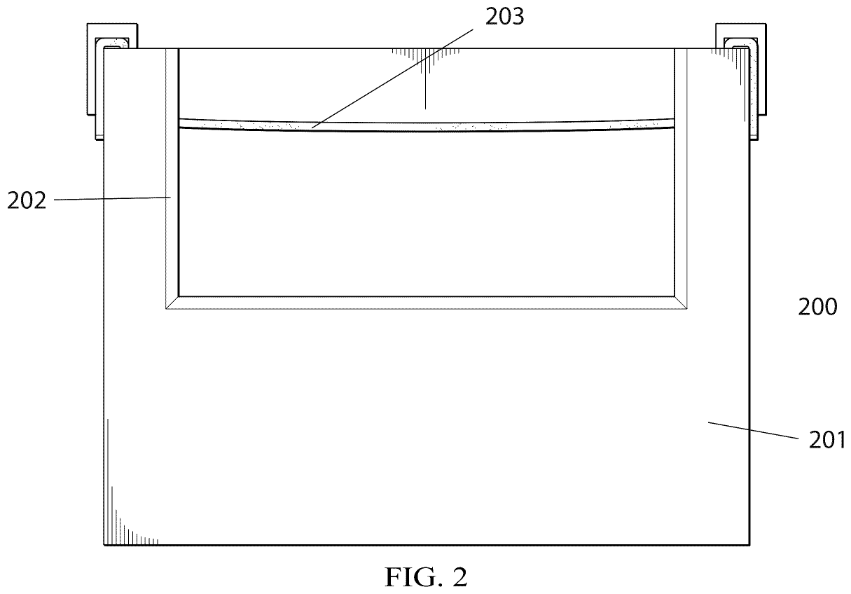

FIG. 2 is a front view of the assembly of FIG. 1. The container 101 201 comprises an opening 202 for receiving a bottle. The opening 202 illustratively features tapered edges. The flexible sheet 103 203 is secured across the length of the container 101 201 such that when the assembly 100 200 receives a bottle, the user may firmly press the bottle to the flexible sheet 203 without making contact with the container walls, ensuring a firm and even application of seasoning.

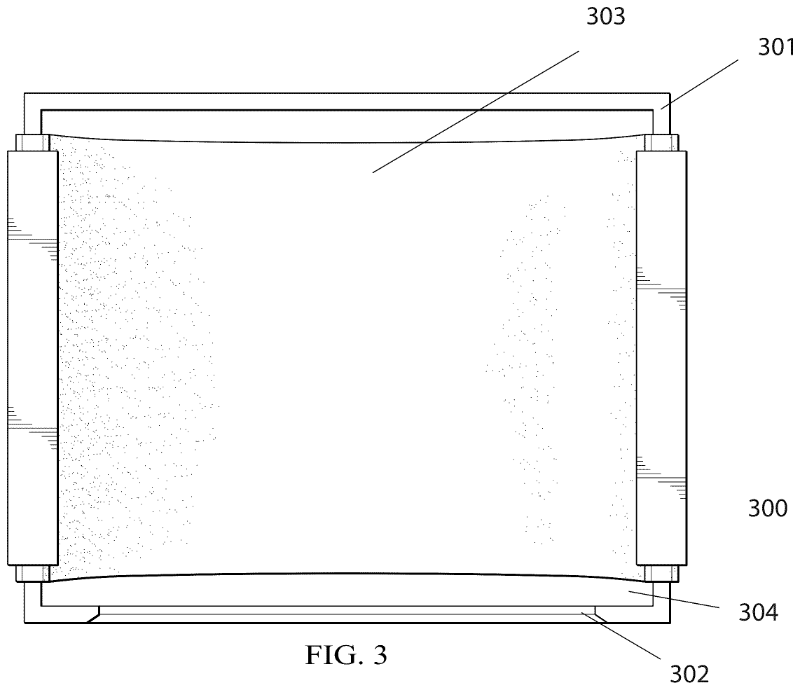

FIG. 3 is a top view of the assembly of FIG. 1. Beverage containers, such as bottles, are inserted through the opening of the container 302. The flexible sheet 103 203 303 extends across the length of the assembly 100 200 300. Notably, the flexible sheet comprises a width that is less than that of the container 101 201 301, such that as the user applies seasoning to the beverage, the leftover seasoning falls to the bottom of the container 108 304, underneath the flexible sheet 303. The leftover salts, sugars, and spices that collect within the container 301 may then be recycled or stored for later use. This in turn reduces operational costs that would otherwise be spent purchasing additional dressing product.

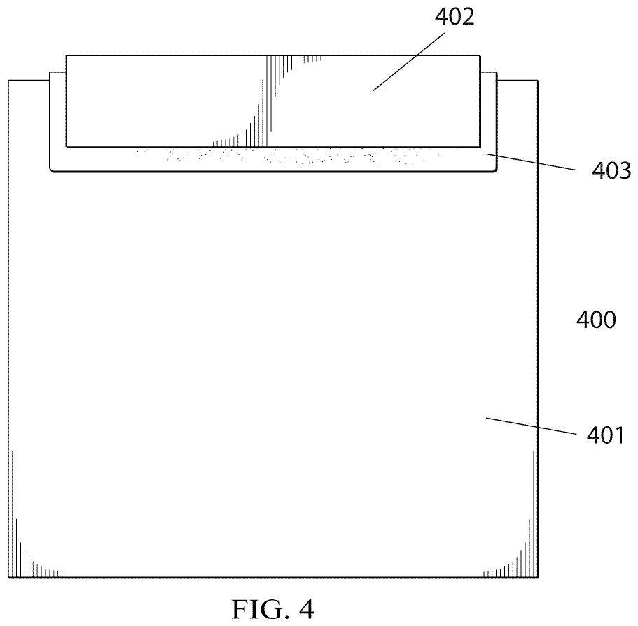

FIG. 4 is a side view of the assembly of FIG. 1. As depicted, the first clip 104 402 anchors the first end of the flexible sheet 105 403 to the container 101 401. The first clip 402 comprises a width such that the flexible sheet may be accommodated therein. The first clip 402 need not be sized according to any particular dimensions. Accordingly, when desired, the first clip 104 may accommodate flexible sheets 103 of varying thicknesses.

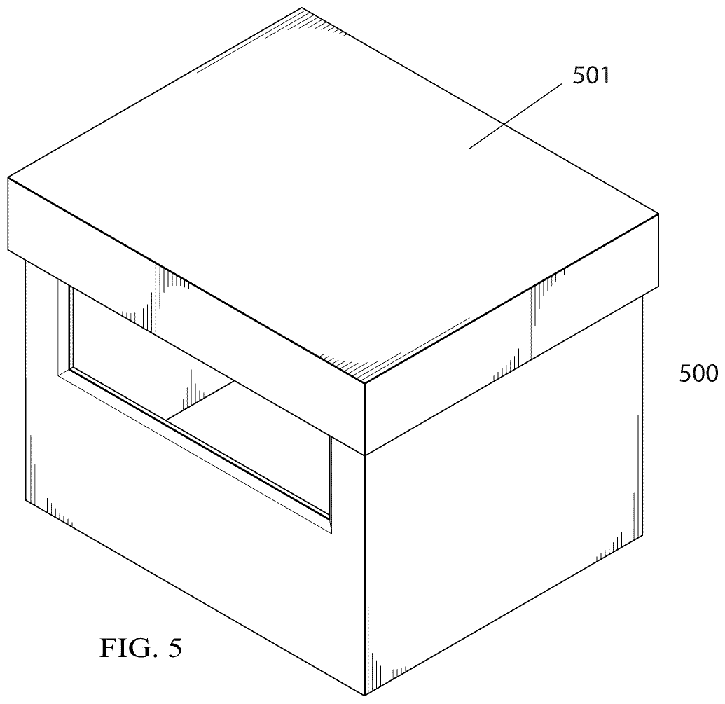

FIG. 5 is a perspective view of a second embodiment of the assembly wherein the assembly further comprises a lid 502 that is designed to be securely attachable to the container 101 201 301 401 501, enhancing the overall practicability of the assembly. The lid 502 not only serves to protect the contents from external contaminants during storage but also facilitates efficient stacking of multiple assemblies for space-saving purposes. When desired the first and second clips 104 106 of the first embodiment can be easily removed, allowing the lid to be placed directly atop the container without obstruction. Users may optionally store the other elements of the preferred embodiment safely within the container 501.

FIG. 6 depicts an environment of use for the assembly. Seasoning 604 is deposited atop the flexible sheet 103 603. A beverage bottle 605 is inserted through the opening of the container 102 602 and is pressed firmly against the flexible sheet 603, applying seasoning to the beverage bottle 605. The beverage bottle 605 is then rotated as it is pressed to the surface of the flexible sheet 603, ensuring that seasoning 604 is evenly applied across the top of the beverage bottle 605. Leftover seasoning 604 then falls into the bottom of the container 108 606, which can be subsequently stored or recycled for later use.

When desired, the user need not insert a beverage container directly through the opening 602. In some instances, a user may be required to dress the rim of a glass or cup. Thus, the user can apply seasoning 604 directly to the cup without inserting the same through the opening 602. When desired, a user can simply flip a cup, or any other beverage container, upside down, directly applying the rim of the container to the flexible sheet 603 and rotating the rim about the flexible sheet, thereby applying seasoning 604. Moreover, the present invention is useful for dressing unevenly shaped fruits and vegetables, such as corn, cucumbers, and pickles. For example, a user may dress a roasted corn by inserting the same through the opening 602, pressing the roasted corn to the surface of the flexible sheet 603, and evenly applying seasoning 604 thereto.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

What is claimed is:

1. An assembly for dressing beverages and fruit, comprising:
a container for receiving seasoning;
a flexible sheet for applying seasoning;
a first clip for securing a first end of the flexible sheet to the container;
a second clip for securing a second end of the flexible sheet to the container.

2. The assembly of claim 1, wherein the container further comprises an opening for receiving a beverage bottle.

3. The assembly of claim 1, wherein the container further comprises rubber feet.

4. The assembly of claim 1, wherein the container is further comprised of polypropylene.

5. The assembly of claim 1, wherein the first clip further comprises teeth for gripping the flexible pad.

6. The assembly of claim 1, wherein the second clip further comprises teeth for gripping the flexible pad.

7. The assembly of claim 1, wherein the flexible sheet is composed of food-grade silicone.

8. The assembly of claim 1, wherein the flexible sheet is composed of food-grade rubber.

9. The assembly of claim 1, wherein the flexible sheet is textured.

10. The assembly of claim 1, wherein the flexible sheet is detachable from the clips.

11. The assembly of claim 1, wherein the flexible sheet is coated with a non-stick material.

12. The assembly of claim 1, wherein the assembly further comprises a lid.
